(19) United States
(12) Patent Application Publication
(10) Pub. No.: US 2022/0074252 A1
(43) Pub. Date: Mar. 10, 2022

(54) STORAGE COMPARTMENT FOR A MOTOR VEHICLE

(71) Applicant: Faurecia Innenraum Systeme GmbH, Hagenbach (DE)

(72) Inventor: Joep Bijlholt, Wissembourg (FR)

(21) Appl. No.: 17/470,460

(22) Filed: Sep. 9, 2021

(30) Foreign Application Priority Data
Sep. 10, 2020 (DE) 10 2020 211 376.9

(51) Int. Cl. E05F 15/63; B60R 7/04

(52) U.S. Cl. CPC E05F 15/63; B60R 7/04; E05Y 2900/538; E05Y 2201/41; E05Y 2201/684; E05Y 2201/422; E05Y 2201/624

(57) ABSTRACT

The present disclosure relates to a storage compartment for a motor vehicle. The storage compartment has an improved mechanism for opening and closing a lid. The storage compartment is particularly suitable for a passenger compartment, such as a storage compartment in an armrest of a center console or as a glove compartment.

### TECHNICAL FIELD

The present invention relates to a storage compartment for a motor vehicle.

### BACKGROUND

Various storage compartments for a passenger compartment are known from the prior art. The storage compartments comprise a receiving chamber for receiving small parts, for example in the form of a glove compartment or in the form of a storage compartment in a center console. These storage compartments typically include at least one pivotable lid for closing the storage compartment. The known lids usually comprise a hook, which in the closed state engages behind a protrusion arranged at the receiving chamber, or in an eye provided there, so as to lock the storage compartment.

These storage compartments have the disadvantage that a knob for unlocking the lid, that is, for releasing the form fit between the hook and the protrusion or the eye, has to be situated in spatial proximity to the hook, so that a mechanism transfers the manual actuating movement of the passenger to a movement of the hook.

### SUMMARY

It is thus the object of the invention to at least partially solve the above-described problem, and to provide an improved storage compartment. In particular, it may be the object of the invention to provide a storage compartment having an improved mechanism for opening and closing a lid.

This object is achieved by a storage compartment having the features of the main claim and/or an alternative storage compartment and/or a vehicle interior lining part according to the other independent claims. Refinements are described in the dependent claims and/or are the subject matter of the following description.

The storage compartment for a motor vehicle is in particular suitable for a passenger compartment, for example as a storage compartment in an armrest of a center console or as a glove compartment.

The storage compartment comprises a receiving chamber with an access opening, a first lid, and a first and a second rotation element.

The access opening is used for reaching into the receiving chamber, so that a user, for example a vehicle occupant, can reach into the receiving chamber to store something therein or to remove something from the receiving chamber.

The receiving chamber can be designed to receive small parts, for example to receive glasses and/or a wallet and/or a cell phone and/or a charging cable and/or money and/or gloves. Electrical connections, for example for charging a cell phone, can be arranged in the storage compartment.

The first lid is pivotably arranged at the receiving chamber. This means that the first lid can be at least partially rotated about a stationary rotation axis that is fixed at the receiving chamber. For example, the lid can be attached to the receiving chamber by way of a hinge. The first lid can be pivoted between a first, open position and a second, closed position. In the closed position, the lid can at least partially or completely cover and close the access opening. In the open position, the lid can at least partially expose the access opening, preferably in such a way that a user is able to reach into the receiving chamber.

In one embodiment, the first lid completely covers the receiving opening in the second, closed position. This can have the advantage that parts stored in the storage compartment cannot fall out while a vehicle in which the storage compartment is arranged is traveling, even in the event of driving-induced vibrations or, for example, as a result of centrifugal forces, and are secured in the storage compartment.

In one embodiment, the first lid only covers a region of the receiving opening in the second, closed position. A second lid can be provided for the non-covered region. It may also be provided that a region cannot be covered by a lid. For example, a cup holder may be arranged there. The access opening can thus be at least partially closed by the lid or lids, while a tall beverage container can be accommodated in a region of the receiving chamber, without impeding closing of the receiving chamber.

The storage compartment comprises a first and a second rotation element. The rotation elements are used to transmit a rotational movement, for example a manual rotational movement, to the lid. The rotation elements can preferably be used to transmit a rotational movement of a motor, and preferably the rotational movement of an output shaft of an electric motor, to the lid. The first rotation element is rotatable about a first rotation axis. The first rotation element can be coupled to the motor in such a way that the motor rotates the first rotation element about the first rotation axis. The second rotation element is rotatably connected to the first rotation element about a second rotation axis. The second rotation element is furthermore rotatably connected to the first lid about a third rotation axis. The first and/or the second rotation elements preferably have a rod-shaped or beam-shaped design, so that the first and/or the second rotation elements each have a first end and a second end. The first end of the first rotation element is preferably rotatably connectable or connected to the motor about the first rotation axis. The first rotation element, preferably the second end of the first rotation element, is rotatably connected to the second rotation element, preferably to the first end of the second rotation element, about a second rotation axis. The second rotation element, preferably the second element of the second rotation element, is rotatably connected to the first lid about a third rotation axis. Driving the first rotation element thus causes a pivoting movement of the first lid for closing and/or opening the first lid.

The first, second and third rotation axes preferably extend parallel to one another. The first rotation axis and the third rotation axis are situated in a first plane. If the lid is in the second, closed position, the second rotation axis is preferably situated in the first plane. In the first, open position of the first lid, the second rotation axis can be situated outside the first plane. The first plane in the first position can deviate from the first plane in the second position. This can be due to the fact that the third rotation axis is, in particular, not stationary, that is, is situated in a different location, relative to the receiving chamber, when the lid is in the first position or in the second position. In contrast, the first rotation axis can be stationary, relative to the receiving chamber. The first plane of the first position thus intersects the first plane of the second position in the first rotation axis. This arrangement of the rotation axes may be advantageous to apply as large a closing force as possible for closing the lid. With the selected arrangement of the rotation axes, as small a horizontal force component as possible can be achieved when closing the lid, just before the lid reaches the second position, so that a vertical closing force component is increased.

It may also be provided that the second rotation axis is not situated in the first plane in the closed position of the first lid. In the closed position of the first lid, a further first plane, in which the second rotation axis and the first rotation axis are situated, can intersect the first plane in the first rotation axis. This further first plane can be situated at a minimal angle with respect to the first plane, wherein the minimal angle is typically an acute angle. In particular, this further first plane can be situated at a minimal angle of no more than 15°, preferably no more than 10°, or no more than 5°, with respect to the first plane. An angle of 0° is particularly preferred, wherein the first plane and the further first plane coincide. This arrangement of the rotation axes may be advantageous to apply as large a closing force as possible for closing the lid. With the selected arrangement of the rotation axes, as small a horizontal force component as possible can be achieved when closing the lid, just before the lid reaches the second position, so that a vertical closing force component is increased.

In one embodiment, the storage compartment comprises a second lid, which is arranged opposite the receiving chamber pivotably between a first, open position and a second, closed position, for at least regionally opening and closing the access opening. This means that a second lid can be provided, which can be at least partially rotated about a stationary rotation axis that is fixed at the receiving chamber. For example, the second lid can be attached to the receiving chamber by way of a hinge. The storage compartment can furthermore comprise a third and a fourth rotation element for transmitting a rotational movement, for example a manual rotational movement, to the lid. The rotation elements can preferably transmit a rotational movement of a motor to the second lid. The transmitted rotational movement can, in particular, cause an opening or a closing of the second lid.

The features that were described with respect to the first lid can be applied to the second lid. Furthermore, features that were described with respect to the first and second rotation elements can be analogously applied to the third and fourth rotation elements.

In one embodiment, the third rotation element can be rotated about a fourth rotation axis. The fourth rotation element can be rotatably connected to the third rotation element about a fifth rotation axis. The fourth rotation element can be rotatably connected to the second lid about a sixth rotation axis. The fourth, fifth and sixth rotation axes can be arranged parallel to one another. In particular, the fourth, fifth and sixth rotation axes can be situated in a second plane when the second lid is in the closed position. The second plane can be spanned by the fourth and sixth rotation axes.

However, it may also be provided that the fifth rotation axis is situated outside the second plane when the second lid is in the closed position. In the closed position of the second lid, a further second plane, which is spanned by the fourth rotation axis with the fifth rotation axis, can intersect the second plane in the fourth rotation axis. This further second plane can be situated at a minimal angle with respect to the second plane, wherein the minimal angle is typically an acute angle. In particular, the further second plane can be situated at a minimal angle of no more than 15°, preferably no more than 10°, or no more than 5°, with respect to the second plane. An angle of 0° is particularly preferred, wherein the second plane and the further second plane coincide. This arrangement of the rotation axes may be advantageous to apply as large a closing force as possible for closing the lid. With the selected arrangement of the rotation axes, as small a horizontal force component as possible can be achieved when closing the lid, just before the lid reaches the second position, so that a vertical closing force component is increased.

In one embodiment, a minimum distance between the first rotation axis and the second rotation axis is smaller than a minimum distance between the second rotation axis and the third rotation axis. A minimum distance between the fourth rotation axis and the fifth rotation axis can be smaller than a minimum distance between the fifth rotation axis and the sixth rotation axis.

In one embodiment, the distance between the second and third rotation axes is identical to the distance between the fifth and sixth rotation axes.

In one embodiment, the distance between the first and the seventh rotation axes is identical to the distance between the fourth and eighth rotation axes.

In the closed position, a minimum distance between the second rotation axis and the third rotation axis can be greater than a minimum distance between the first rotation axis and the third rotation axis. In the closed position, a minimum distance between the fifth rotation axis and the sixth rotation axis can be greater than a minimum distance between the fourth rotation axis and the sixth rotation axis.

In the open position of one embodiment, a minimum distance between the second rotation axis and the third rotation axis can be smaller than a minimum distance between the first rotation axis and the third rotation axis. In the closed position of one embodiment, a minimum distance between the fifth rotation axis and the sixth rotation axis can be greater than a minimum distance between the fourth rotation axis and the sixth rotation axis.

In the open position, the second rotation axis is typically situated outside a plane spanned by the first and second rotation axes. In the open position, the fifth rotation axis is typically situated outside a plane spanned by the fourth and sixth rotation axes.

In one embodiment, the first and/or fourth rotation axes are fixed with respect to the receiving chamber. Regardless of the lid movement, the first and/or fourth rotation axes are then stationary with respect to the receiving chamber.

In a preferred embodiment, the first and second planes are parallel to one another when the first and second lids are in the closed position. Typically, the first, second and third rotation axes are situated in the first plane in the process, and the fourth, fifth and sixth rotation axis are situated in the second plane.

In one embodiment, the first and third rotation elements are coupled in such a way that the first and second lids close and/or synchronously when either the first or the third rotation element is driven. This can be advantageous, for example, in the case of a storage compartment comprising two lids, for example in a vehicle center console armrest. In a vehicle center console armrest, the storage compartment can comprise a so-called butterfly lid, which comprises two lids that can be pivoted apart in opposite directions of rotation. The first and third rotation elements can be coupled in such a way that it is possible to synchronously pivot the lids open or closed.

In one embodiment, for opening, the first lid can preferably be pivoted in a first direction of rotation and the second lid can preferably be pivoted in a second direction, wherein the second direction of rotation is opposite the first direction of rotation. For closing, the first lid can then preferably be pivoted in a second direction of rotation, and the second lid can preferably be pivoted in the first direction of rotation.

To enable this function, a connecting element can be provided, for example, which, for example at a first end, is rotatably connected to the first rotation element about a seventh rotation axis and, for example at a second end, is rotatably connected to the third rotation element about an eighth rotation axis.

The seventh rotation axis can, in particular, be parallel to the first rotation axis. In particular, the seventh rotation axis can be arranged in one plane together with the first and second rotation axes.

In addition or as an alternative, the eighth rotation axis can be arranged parallel to the fourth rotation axis. The eighth rotation axis can be arranged so that the fourth rotation axis is situated in one plane together with the fifth and eighth rotation axes.

In a preferred embodiment, the seventh rotation axis is arranged between the first rotation axis and the second rotation axis, and the fourth rotation axis is arranged between the eighth rotation axis VIII and the fifth rotation axis.

In this embodiment, the seventh rotation axis is, in particular, arranged between the first rotation axis and the second rotation axis when, in all positions of the first lid, a line through the eighth rotation axis and the seven rotation axis intersects a connecting line that extends from the first rotation axis to the second rotation axis. This is preferably achieved when the seventh rotation axis is arranged between the first rotation axis and the second rotation axis so that the seventh rotation axis is situated in the same plane as the first rotation axis and the second rotation axis.

In particular, the fourth rotation axis is arranged between the fifth rotation axis and the seventh rotation axis when, in all positions of the second lid, a line through the eighth rotation axis and the seventh rotation axis intersects a connecting line that extends from the fifth rotation axis to the eighth rotation axis. This is preferably achieved when the fourth rotation axis is arranged between the fifth rotation axis and the eighth rotation axis so that the fourth rotation axis is situated in the same plane as the fifth rotation axis and the eighth rotation axis.

In the closed position of the first lid, the seventh rotation axis is preferably situated in the first plane. In the closed position of the second lid, the eighth rotation axis is preferably situated in the second plane.

A first group of axes can comprise the first, second, third and seventh rotation axes. A second group of axes can comprise the fourth, fifth, sixth and eighth rotation axes. The rotation axis of the first lid and/or one or more rotation axes from the first group of axes can be parallel to the rotation axis of the second lid and/or one or more rotation axes from the second group of axes. In other embodiments, the rotation axis of the first lid and the rotation axis of the second lid may not be parallel. In such embodiments, one ball and socket joint or multiple ball and socket joints can be used to enable the necessary relative movements.

In one embodiment, a distance between the first and seventh rotation axes is identical to a distance between the eighth and fourth rotation axes.

The storage compartment can comprise a rail, preferably in the shape of a circular arc, for guiding the connecting element. For this purpose, a pin, for example, can be arranged at the connecting element, which is guided in the rail. The pin can move in the rail when the lid is being closed.

In addition or as an alternative, the storage compartment can comprise a pivoting arm for guiding the connecting element. The pivoting arm can be rotatably connected to the connecting element and rotatably connected to the receiving chamber.

The storage compartment can comprise at least one motor. The at least one motor can be connected to the first rotation element and/or the third rotation element for driving the first rotation element about the first rotation axis and/or for driving the third rotation element about the fourth rotation axis. In this way, the first and/or second lids can be opened and/or closed, preferably both synchronously.

The at least one motor can be designed as an electric motor. The motor can be designed to drive the first or third rotation element in two directions of rotation. A first direction of rotation of the motor can cause the lid to open, and a second direction of rotation can cause the lid to close.

At an upper side of the receiving chamber, which in the closed state comes in contact with the first and/or second lids, and/or at the first and/or second lids, in a region that, in the closed state, comes in contact with the receiving chamber, the storage compartment can comprise an elastic element. This element can be used to avoid, or at least reduce, noise during closing due to the contact between the first and/or second lids and the receiving chamber. As an alternative or in addition, it can be used to avoid damage to the lid and/or to the receiving chamber in the region of the contact surfaces. The elastic element can be designed as a rubber damper. The elastic element can comprise materials such as caoutchouc, rubber, EPDM and/or silicone. The storage compartment and/or the lid can comprise a plastic material, for example PP or ABS, a metal, for example aluminum, wood, stone, a ceramic material and/or plexiglass. The above-described arrangement of the rotation axes can, in particular, be advantageous to generate the necessary force for compressing the elastic element so as to close the storage compartment.

In one embodiment, the first and/or second lids are held in the closed and/or open position, for example in that a motor coupled to the first rotation element is stopped. In addition or as an alternative, it may be provided that an elastic element holds the first and/or second lids in the closed and/or open position. It may be advantageous in the process when the elastic element only holds the first and/or second lids in the closed and/or open position upon reaching. For this purpose, a first force can be exerted on the elastic element. Such a holding state can be overcome, for example, for closing or opening again when a force is again exerted on the elastic element.

An activation switch for activating the motor can be connected to the motor. The activation switch can be connected to the motor by a cable or wirelessly. The activation switch can be designed in such a way that a first actuation causes a first direction of rotation of the motor, and a renewed actuation causes an opposite direction of rotation. The activation switch can alternatively encompass two actuation positions, wherein a first position initiates the first direction of rotation, and the second position initiates the opposite direction of rotation. The motor can be designed so as to stop upon reaching the first, open lid position or upon reaching the second, closed lid position. The activation switch can be designed as a controller. The controller can be designed as a control dial, for example. A rotation in the one or other direction can correspond to the direction of rotation of the motor, for example. It is also possible for a controller to be provided that allows an increase/a decrease in speed of the opening and/or closing process. The motor can also be activated in another manner, for example by way of so-called gesture recognition or gesture control.

It may also be provided that further lids are provided, which comprise equivalent mechanisms for opening and closing. For example, four lids can be provided, wherein two lids can in each case be designed in accordance with the described first and second lids, and can preferably be opened and closed synchronously.

It shall be noted that it is described in the present application that rotation elements or lids can in each case be rotated about one or more rotation axes. This means that a rotation element and/or lid can be at least partially rotated about a rotation axis, and is not necessarily completely rotatable, that is, by 360°, about this rotation axis. For example, the lid or a rotation element can be rotatable about the particular rotation axis within an angular range of less than 360°, in particular less than 270°, and/or more than 0°, in particular more than 45°.

When an embodiment is mentioned above or hereafter, this does not preclude a feature or multiple features of such an embodiment from being combined with a feature or multiple features of other embodiments.

### BRIEF DESCRIPTION OF THE DRAWINGS

Exemplary embodiments are described in connection with the following figures.

FIG. 1 shows a storage compartment comprising a first lid;

FIG. 2 shows a storage compartment according to FIG. 1, furthermore comprising a second lid;

FIG. 3 shows a storage compartment according to FIG. 2, comprising a rail instead of a pivoting arm;

FIG. 4 shows a storage compartment according to FIG. 2, furthermore comprising an elastic element;

FIG. 5 shows a storage compartment according to FIG. 4, the lids being shown in a closed position;

FIG. 6 shows a storage compartment according to FIG. 4 during a closing process, just prior to the lids being closed; and

FIG. 7 shows a storage compartment for a center console of a vehicle.

### DETAILED DESCRIPTION

Recurring features are denoted by the same reference numerals.

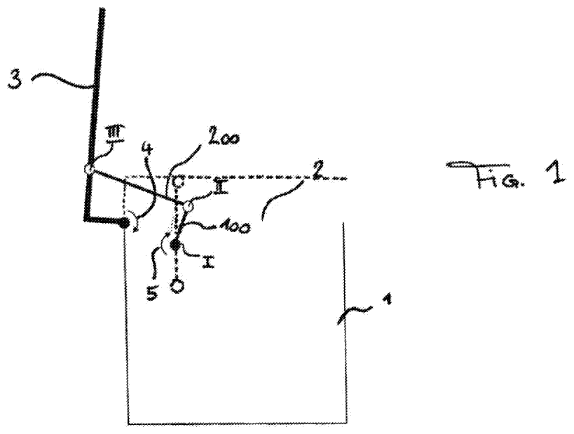

FIG. 1 shows a storage compartment in a sectional side view as a schematic sketch. The storage compartment comprises a receiving chamber 1. The receiving chamber is formed by side walls and a bottom. The receiving chamber 1 is open toward the top and includes an opening 2. A lid 3 is rotatably arranged, for example by means of a hinge, at the receiving chamber 1. The lid 3 is shown in an open position. The lid can be pivoted in the direction of the arrow 4 into a closed position. The storage compartment comprises a mechanism for pivoting the lid 3 in an automated manner. The mechanism comprises a first rotation element 100. The rotation element 100 can be rotated about a first rotation axis I. The first rotation axis I is stationary with respect to the receiving chamber. For example, a pivot bearing, which enables the first rotation element 100 to rotate about the first rotation axis I, is directly or indirectly connected to the receiving chamber 1. The mechanism furthermore comprises a second rotation element 200, which is rotatably connected to the first rotation element 100. The first rotation element and the second rotation element have a rod-shaped design. At a first end, the second rotation element 200 is rotatably connected to the first rotation element 100 about a second rotation axis II. At a second end, the second rotation element 200 is rotatably connected to the lid 3 about a third rotation axis III. The first rotation element 100 can be driven in the direction of the arrow 5 to close the lid. For this purpose, an electric motor (not shown) is coupled to the first rotation element 100 in such a way that the rotation of an output shaft of the electric motor is transmitted to the first rotation element 100, so that this rotation element rotates about the first rotation axis I. For example, the output shaft can be located in the first rotation axis I. It is also possible for an upstream gear to be provided for adapting the motor speed.

As a result of the rotation of the first rotation element 100 in the direction of the arrow 5 for closing the lid, the first end of the second rotation element and the second rotation axis rotate clockwise about the first rotation axis I. The motor torque is thus transmitted via the first rotation element 100 and the second rotation element 200 to the lid 3, so that the lid moves into a second, closed position (shown with a dotted line). In the closed position (shown with a dotted line), the first, second and third rotation axes I, II, III are situated in one plane. The first, second and third rotation axes I, II, III extend parallel to one another.

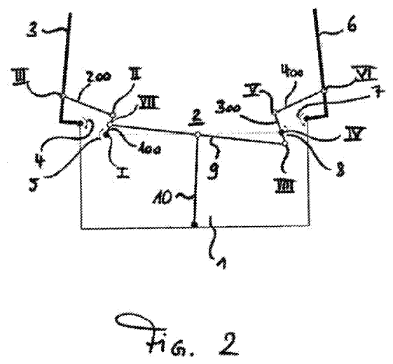

FIG. 2 shows a storage compartment according to FIG. 1, wherein the storage compartment comprises a second lid 6, which is pivotably mounted at the receiving chamber 1. The opening 2 is covered when the first lid 3 and the second lid 6 are in the closed state.

In FIG. 2, the lids 3 and 6 are each shown in the open position. The storage compartment comprises a third rotation element 300, which can be rotated about a fourth rotation axis IV. The third rotation element 300 is rotatably coupled about a fifth rotation axis V to a first end of a fourth rotation element 400. At a second end, this fourth rotation element is rotatably connected to the second lid 6 about a sixth rotation axis VI. The fourth, fifth and sixth rotation axes IV, V, VI extend parallel to one another and are likewise parallel to the rotation axes I, II and III. The lid is pivoted counterclockwise, as is shown by arrow 7, for moving the second lid 6 from the open position into the closed position. In this way, the direction of rotation of the lid 6, when moving the second lid 6 from the open to the closed position, is opposite the direction of rotation of the first lid 3 when moving the first lid 3 from the open to the closed position. So as to close the second lid 6, the third rotation element 300 is rotated counterclockwise, shown by arrow 8, about the fourth rotation axis IV. The first end of the fourth rotation element 400, and thus also the fifth rotation axis V, thus move about the fourth rotation axis IV during a closing process.

The first rotation element 100 and the third rotation element 300 are coupled via a connecting element 9. The connecting element 9 has a rod-shaped design. At a first end, the connecting element 9 is rotatably connected about a seventh rotation axis VII to the first rotation element 100. At a second end, the connecting element 9 is rotatably connected about an eighth rotation axis VIII to the third rotation element 300. The seventh rotation axis VII and the eighth rotation axis VIII extend parallel to the further rotation axes I to VI. In another embodiment, the rotation axes IV, VII and the lid 3, 6 are not parallel, and the connecting element 9 comprises a ball and socket joint at the connection to one or both of the rotation elements 100, 300.

The attachment point of the connecting element 9 at the first rotation element 100, and thus also the seventh rotation axis VII extending through this point, are arranged between the second and first rotation axes. A minimum distance between the first rotation axis I and the second rotation axis II is thus greater than a minimum distance between the seventh rotation axis VII and the first rotation axis I. The first, second and seventh rotation axis I, II, VII are situated in one plane. In this embodiment, the distance between the first rotation axis I and the second rotation axis II is smaller than the distance between the second rotation axis II and the third rotation axis. For example, the distance between the first rotation axis I and the second rotation axis II is 17 mm, and the distance between the second rotation axis II and the third rotation axis is 25 mm.

The attachment point of the connecting element 9 to the third rotation element 300, and thus also the eighth rotation axis VIII, is arranged in such a way that a minimum distance between the eighth rotation axis VIII and the fifth rotation axis V is greater than a minimum distance between the fourth rotation axis IV and the fifth rotation axis V. In this embodiment, the distance between the fourth rotation axis IV and the fifth rotation axis V is smaller than the distance between the fifth rotation axis V and the sixth rotation axis VI. For example, the distance between the fourth rotation axis IV and the fifth rotation axis V is 17 mm, and the distance between the fifth rotation axis V and the sixth rotation axis is 25 mm.

Driving the first rotation element 100 in the direction of the arrow 5 thus causes a rotation of the first rotation element 100 as well as a rotation of the third rotation element 300 in the direction of the arrow 8. As described above, this causes the lids 3 and 6 to be closed. Synchronous closing of the lids 3 and 6 can thus be achieved by driving the first rotation element 100. When the first rotation element is driven in the direction opposite that of the arrow 5, and when the lids 3 and 6 are in the closed position, the third rotation element 300 is also driven in the direction opposite that of the arrow 8, so that the lid is opened.

Similarly, the third rotation element can be driven, instead of the first rotation element 100, for synchronously opening or closing the lids 3, 6. The storage compartment of FIG. 2 furthermore comprises a pivoting arm 10, which at a first end is coupled to the receiving chamber 1 and at a second end is rotatably hinged to the connecting element 9. The pivoting arm is used to guide and stabilize the opening/closing mechanism.

The pivoting arm 10 preferably has a length a between the first end, which is hinged to the receiving chamber 1, and the second end connected to the connecting element. A minimum distance between the seventh and eighth rotation axes VII, VIII is preferably 2 a.

A distance 13 between the first rotation axis I and the seventh rotation axis VII is preferably identical to the distance 14 between the fourth rotation axis IV and the eighth rotation axis VIII. This distance is particularly preferably 0.136 a. The distance between the second rotation axis II and the third rotation axis III preferably corresponds to the distance between the fifth rotation axis V and the sixth rotation axis VI.

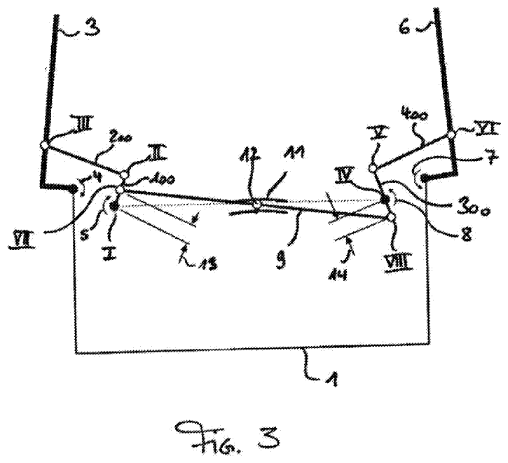

As an alternative or in addition to the pivoting arm 10, the storage compartment can comprise a rail for guiding the connecting element 9. A storage compartment comprising a rail instead of the pivoting arm 10 is shown in FIG. 3, for example. The rail has a circular arc-shaped design. A pin 12 is arranged at the connecting element 9, which protrudes into the rail and is guided therein. A movement of the first rotation element 100 in the direction of the arrow 5 for moving the lid from the open position (shown in FIG. 3) into the closed position initially causes the pin 12 to be displaced to the right within the rail 11. A rotation of the first rotation element 100 counter to the direction of the arrow 5 for moving the lid 3 or 4 from the closed position into the open position causes the pin 12 to be displaced to the left.

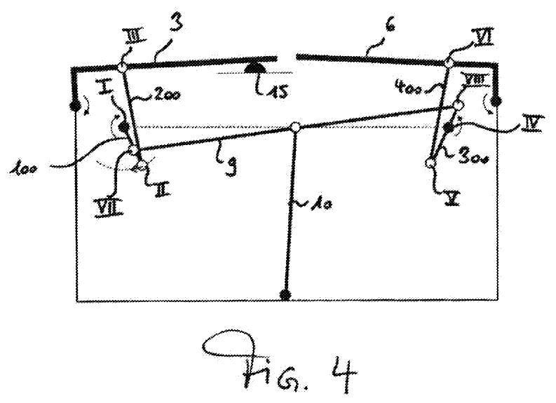

FIG. 4 shows a storage compartment according to FIG. 2, furthermore comprising an elastic element 15. The figure shows the elastic element 15 in connection with an embodiment of the storage compartment comprising a pivoting arm 10. All features described with respect to FIG. 4 can be applied to a storage compartment comprising a rail 11 according to FIG. 3 or to a storage compartment comprising a rail 11 and a pivoting arm 10.

The elastic element is arranged on an upper side of the receiving chamber 1. In particular, it is arranged in a region of the receiving chamber 1 that comes in contact with the lid 3 when the lid 3 is being closed. FIG. 4 shows only one elastic element. The exemplary embodiment, however, can comprise multiple elastic elements. These can preferably be arranged in a region of the receiving chamber 1 that comes in contact with the lid 3 when the lid 3 is being closed, or comes in contact with the lid 6 when the lid 6 is being closed. One or more elastic elements 15, however, can also be arranged at the lid 3 and/or 6, in particular in a region of the lid 3 and/or of the lid 6 that comes in contact with the receiving chamber 1 when the lid 3 and/or 6 is being closed.

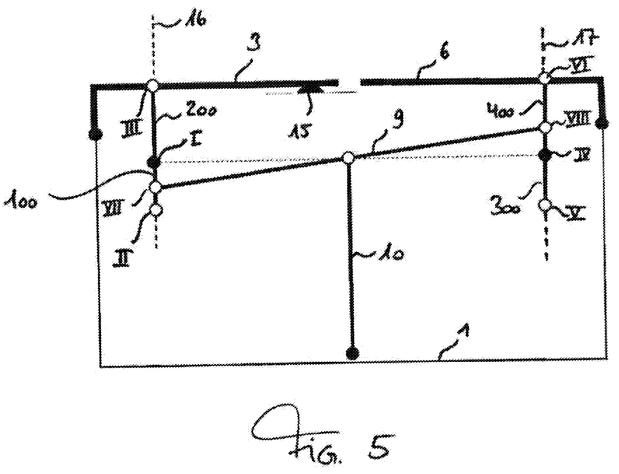

FIG. 4 shows the lids 3 and 6 in an almost closed position. The lid 3 makes contact with the elastic element 15. During the further course of the closing process, the lid 3 pushes on the elastic element 15, compressing it. This closed state is shown in FIG. 5. In FIG. 5, the lid 3 compresses the elastic element 15. The first, second, third and seventh rotation axes I, II, III and VII are situated in a plane that extends orthogonally to the image plane through the straight line 16 indicated by a dotted line. The fourth, fifth, sixth and eighth rotation axes IV, V, VI and VIII are situated in a plane that extends orthogonally to the image plane through the straight line 17 indicated by a dotted line.

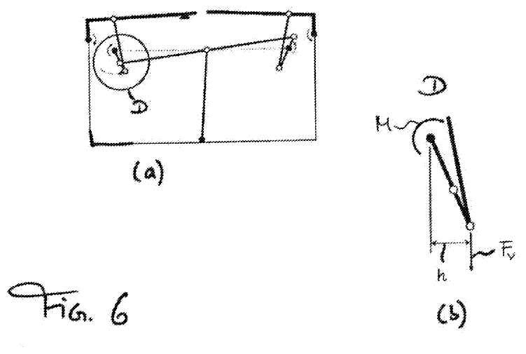

This arrangement has the advantage that a vertical force Fᵥ transmitted from the motor to the lid via the first and second rotation elements for closing the lid is increased just prior to closing. The force for closing is composed of a torque M of the motor and a horizontal distance h. FIG. 6(a) corresponds to FIG. 4, wherein a circle D is plotted, which determines a section that is shown as a detailed section in FIG. 6(b). FIG. 6(a), and thus also FIG. (b), shows the closing process at a point in time just prior to the lids 3 and 6 being closed. The distance h is thus smaller compared to the distance h at a point in time immediately prior to the shown point in time. When the torque of the motor remains the same, the force component Fᵥ is comparatively larger than at a point in time immediately prior to the shown point in time. In this way, a relatively high closing force can be generated, and the elastic element 15 can be compressed.

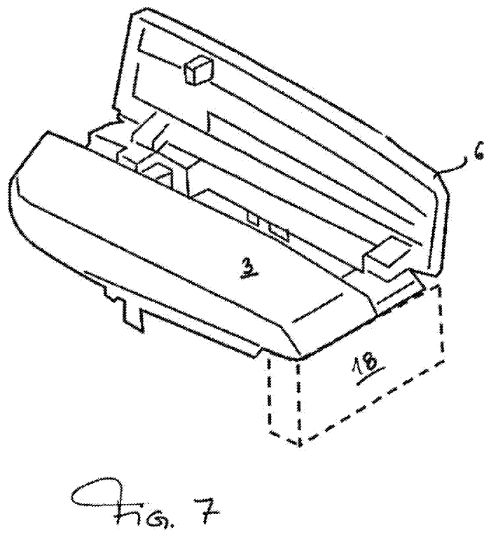

FIG. 7 shows a storage compartment for a motor vehicle, in particular for a center console. The storage compartment comprises a first lid 3 and a second lid 6. For illustration purposes, the lid 3 is shown to be closed, and the lid 6 is shown to be open. However, the lids 3 and 6 can in particular be opened or closed synchronously. This means that the lids 3 and 6 are preferably both either closed or both open. It shall be noted that it is also possible to open or close the lids independently of one another. In this case, each of the lids could, for example, be provided with a mechanism according to FIG. 1. Each of the mechanisms could comprise a motor. It would also be conceivable to provide a motor that can be coupled to the first or the second mechanism by way of an adjustable coupling.

The storage compartment, however, preferably comprises a mechanism for synchronously opening and closing the lids 3 and 6, as described above in FIGS. 2 to 6. This mechanism can be arranged, as is shown with dotted lines in FIG. 7, in a box 18.

### LIST OF REFERENCE SIGNS

1 receiving chamber
2 opening
3 first lid
4 direction of rotation of the first lid during closing
5 direction of rotation of the first rotation element during closing
6 second lid
7 direction of rotation of the second lid during closing
8 direction of rotation of the third rotation element during closing
9 connecting element
10 pivoting arm
11 guide rail
12 pin
13 distance between the first and seventh rotation axes
14 distance between the third and eighth rotation axes
15 elastic element
16 straight line for defining the first plane
17 straight line for defining the second plane
18 box
100 first rotation element
200 second rotation element
300 third rotation element
400 fourth rotation element
I first rotation axis
II second rotation axis
III third rotation axis
IV fourth rotation axis
V fifth rotation axis
VI sixth rotation axis
VII seventh rotation axis
VIII eighth rotation axis
D detail section
Fᵥ vertical component of the closing force
h horizontal distance
M motor torque

1. A storage compartment for a motor vehicle, comprising:
a receiving chamber with an access opening for reaching into the receiving chamber,
a first lid and a second lid, each arranged to be pivotable with respect to the receiving chamber between a first, open position and a second, closed position,
a first rotation element and a second rotation element,
wherein the first rotation element is rotatable about a first rotation axis and the second rotation element is rotatably connected to the first rotation element about a second rotation axis and to the first lid about a third rotation axis,
a third rotation member and a fourth rotation member, wherein the third rotation member is rotatable about a fourth rotation axis and the fourth rotation member is rotatably connected to the third rotation member about a fifth rotation axis and to the second lid about a sixth rotation axis,
a connecting element rotatably connected to the first rotational element about a seventh rotational axis and rotatably connected to the third rotation member about an eighth rotational axis,
wherein the seventh rotation axis is arranged between the first rotation axis and the second rotation axis and the fourth rotation axis is arranged between the eighth rotation axis and the fifth rotation axis.

2. The storage compartment according to claim 1, wherein at least one of the first rotation axis and the fourth rotation axis are fixed with respect to the receiving chamber.

3. The storage compartment according to claim 1, characterized in that wherein at least one of (1) the first rotation axis, the second rotation axis and the third rotation axis are arranged parallel to one another, (2) the fourth rotation axis, the fifth rotation axis and the sixth rotation axis are arranged parallel to one another, and (3) the first rotation axis to the eighth rotation axis are arranged parallel to one another.

4. The storage compartment according to claim 1, wherein at least one of (1) when the first lid is in the closed position, a first minimal angle between a first plane and a further first plane is at most 15°, the first rotation axis and the third rotation axis being situated in the first plane, and the first rotation axis and the second rotation axis being situated in the further first plane,
and
(2) when the second lid is in the closed position, a second minimal angle between a second plane and a further second plane is at most 15°, the fourth rotation axis and the sixth rotation axis being situated in the second plane, and the fourth rotation axis and the fifth rotation axis being situated in the further second plane.

5. The storage compartment according to claim 1, wherein at least one of (1) the first rotation axis, the second rotation axis and the third rotation axis are situated in a first plane when the first lid is in the closed position,
and
(2) the fourth rotation axis, the fifth rotation axis and the sixth rotation axis are situated in a second plane when the second lid is in the closed position.

6. The storage compartment according to claim 4, wherein the first minimal angle and the second minimal angle are equal in size when the first lid and the second lids are in the closed position.

7. The storage compartment according to claim 5, wherein the first plane and the second planes are parallel to one another when the first lid and the second lid are in the closed position.

8. The storage compartment according to claim 1, further comprising at least one of:
(1) a rail for guiding the connecting element; and
(2) a pivoting arm for guiding the connecting element, the pivoting arm being rotatably connected to the connecting element and rotatably connected to the receiving chamber.

9. The storage compartment according to claim 1, further comprising a motor connected to at least one of the first rotation element and to the third rotation element, for driving at least one of the first rotation element about the first rotation axis and the third rotation element about the fourth rotation axis so that the first lid and the second lid at least one of opened and closed.

10. A storage compartment for a motor vehicle, comprising:
a receiving chamber with an access opening for reaching into the receiving chamber,
a first lid, which is arranged pivotably with respect to the receiving chamber between a first, open position and a second, closed position, for at least regionally opening and closing the access opening,
a first rotation element and a second rotation element, the first rotation element being rotatable about a first rotation axis, and the second rotation element being rotatably connected to the first rotation element about a second rotation axis and to the first lid about a third rotation axis,
wherein when the first lid is in the closed position, a minimal angle between a first plane and a further first plane is at most 15°, the first rotation axis and the third rotation axis being situated in the first plane, and the first rotation axis and the second rotation axis being situated in the further first plane.

11. The storage compartment according to claim 4, wherein the first minimal angle is at most 10°.

12. The storage compartment according to claim 11, wherein the first minimal angle is at most 5°.

13. The storage compartment according to claim 4, wherein the second minimal angle is at most 10°.

14. The storage compartment according to claim 13, wherein the second minimal angle is at most 5°.

15. The storage compartment according to claim 8, wherein the rail comprises a shape of a circular arc.

16. The storage compartment according to claim 9, wherein the motor drives the at least one of the first rotation element about the first rotation axis and the third rotation element about the fourth rotation axis so that the first lid and the second lid are at least one of synchronously opened and synchronously closed.

17. The storage compartment according to claim 10, wherein the minimal angle is at most 5°.

18. The storage compartment according to claim 17, wherein the minimal angle is 0°.
